(19) United States
(12) Patent Application Publication
(10) Pub. No.: US 2025/0201448 A1
(43) Pub. Date: Jun. 19, 2025

(54) MULTI-CORE CABLE

(71) Applicant: SUMITOMO ELECTRIC INDUSTRIES, LTD., Osaka (JP)

(72) Inventors: Motoi MATSUDA, Tochigi (JP); Satoshi OKANO, Tochigi (JP)

(73) Assignee: SUMITOMO ELECTRIC INDUSTRIES, LTD., Osaka (JP)

(21) Appl. No.: 18/963,925

(22) Filed: Nov. 29, 2024

(30) Foreign Application Priority Data
Dec. 14, 2023 (JP) 2023-211444

(51) Int. Cl. H01B 11/10

(52) U.S. Cl. CPC H01B 11/10

(57) ABSTRACT

A multi-core cable includes a core formed of four insulated wires twisted together, a shield layer, and a jacket. The four insulated wires are constituted by two first wires and two second wires. An outside diameter of each of the first wires is larger than an outside diameter of each of the second wires. In a cross-section of the core perpendicular to a longitudinal direction thereof, a center of each of the first wires is positioned on a first diagonal line of a quadrangular shape formed by a line connecting centers of the four insulated wires, and a center of each of the second wires is positioned on a second diagonal line of the quadrangular shape. The first wires are in contact with each other, and in contact with the second wires adjacent to the first wires.

### CROSS REFERENCE TO RELATED APPLICATIONS

This application claims priority based on Japanese Patent Application No. 2023-211444 filed on Dec. 14, 2023, and the entire contents of the Japanese Patent Application are incorporated herein by reference.

### TECHNICAL FIELD

The present disclosure relates to a multi-core cable.

### BACKGROUND

Patent literature (Japanese Unexamined Patent Application Publication No. 2003-132743) discloses a signal transmission cable including a quad-structure wire formed of four insulation-coating center conductors bundled together so as to form a quad-structure.

### SUMMARY

A multi-core cable according to the present disclosure includes a core formed of four insulated wires twisted together, a shield layer disposed on an outer side of the core, and a jacket disposed on an outer side of the shield layer. The four insulated wires are constituted by two first wires and two second wires. An outside diameter of each of the first wires is larger than an outside diameter of each of the second wires. In a cross-section of the core perpendicular to a longitudinal direction of the core, a center of each of the two first wires is positioned on a first diagonal line of a quadrangular shape formed by a line connecting centers of the four insulated wires, a center of each of the two second wires is positioned on a second diagonal line of the quadrangular shape, the two first wires are in contact with each other, and the first wires are in contact with the second wires disposed adjacent along an outside circumference of the core to the first wires.

### BRIEF DESCRIPTION OF DRAWINGS

FIG. 1 is a cross-sectional view of a multi-core cable in a plane perpendicular to a longitudinal direction of the multi-core cable according to an embodiment of the present disclosure.

FIG. 2 is a cross-sectional view of a multi-core cable produced in Experimental Example 2 in the plane perpendicular to the longitudinal direction of the multi-core cable.

FIG. 3 is an evaluation result of an attenuation of the multi-core cables produced in Experimental Example 1 and Experimental Example 2.

### DETAILED DESCRIPTION

In a multi-core cable having four insulated wires, a phenomenon called suck-out in which a sharp decrease in attenuation occurs in a certain frequency region may occur. An object of the present disclosure is to provide a multi-core cable in which the occurrence of suck-out is suppressed.

Embodiments will be described below.

### Description of Embodiments of Present Disclosure

First, embodiments of the present disclosure will be listed and described. In the following description, the same or corresponding elements are denoted by the same reference numerals, and the same description thereof will not be repeated.

(1) A multi-core cable according to an aspect of the present disclosure includes a core formed of four insulated wires twisted together, a shield layer disposed on an outer side of the core, and a jacket disposed on an outer side of the shield layer. The four insulated wires are constituted by two first wires and two second wires. An outside diameter of each of the first wires is larger than an outside diameter of each of the second wires. In a cross-section of the core perpendicular to a longitudinal direction of the core, a center of each of the two first wires is positioned on a first diagonal line of a quadrangular shape formed by a line connecting centers of the four insulated wires, a center of each of the two second wires is positioned on a second diagonal line of the quadrangular shape, the two first wires are in contact with each other, and the first wires are in contact with the second wires disposed adjacent along an outside circumference of the core to the first wires.

The four insulated wires are constituted by two first wires and two second wires, the outside diameter of each of the first wires is larger than the outside diameter of each of the second wires, and the two first wires are disposed so as to be in contact with each other in the cross-section of the core perpendicular to the longitudinal direction of the core. This can suppress the occurrence of suck-out.

(2) In (1), a ratio of the outside diameter of each of the second wires to the outside diameter of each of the first wires may be 0.2 to 0.7.

By setting the ratio of the outside diameter of each of the second wires to the outside diameter of each of the first wires to 0.2 to 0.7, the shapes of the shield layer and the jacket can be made closer to a perfect circle in a cross-section of the multi-core cable perpendicular to a longitudinal direction of the multi-core cable. Thus, the handling properties of the multi-core cable can be improved. In addition, it is possible to suppress a variation in a distance between the second wires at positions along the longitudinal direction of the multi-core cable, thereby particularly stabilizing transmission characteristics of a signal propagated through the second wire.

(3) In (1) or (2), in the cross-section of the multi-core cable perpendicular to the longitudinal direction of the multi-core cable, a ratio of a minimum value of an outside diameter of the multi-core cable to a maximum value of the outside diameter of the multi-core cable may be 0.9 to 1.0.

By setting the ratio of the minimum value to the maximum value of the outside diameter in the cross-section perpendicular to the longitudinal direction to 0.9 to 1.0, the cross-sectional shape of the multi-core cable according to an embodiment of the present disclosure can be made closer to a perfect circle, thereby improving the handling properties of the multi-core cable.

### Details of Embodiments of Present Disclosure

A specific example of a multi-core cable according to one embodiment of the present disclosure (hereinafter, referred to as “the present embodiment”) will be described below with reference to the drawings. The present invention is not limited to these examples, but is defined by the scope of the claims, and is intended to include all modifications within the meaning and scope equivalent to the scope of the claims.

In this specification, the ordinal number “first”, “second”, or the like may be added to the name of a member for description, such as a first wire, a second wire, a first conductor, a second conductor, a first insulator, or a second insulator. The ordinal numbers “first”, “second”, and the like are used only to distinguish the respective members and to prevent confusion in the description, and do not represent arrangement, priority, and the like. Thus, when there is no particular possibility of confusion or when the description is made collectively, the terms “wire”, “conductor”, and “insulator” can be simply used.

### [Multi-Core Cable]

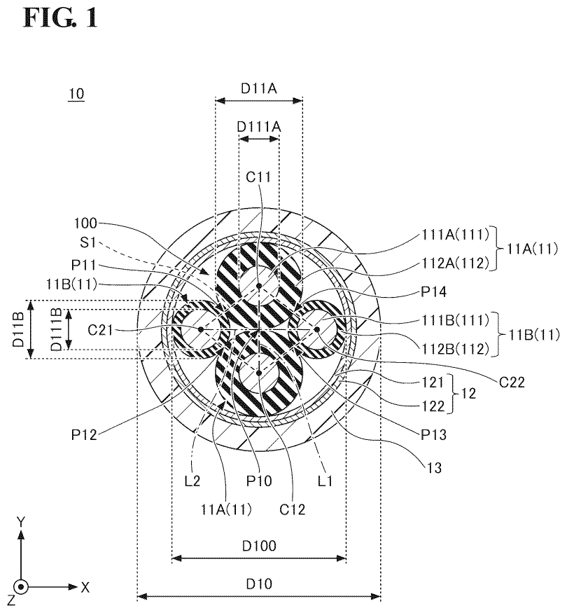

FIG. 1 shows a configuration example of a cross-section of a multi-core cable 10 of the present embodiment perpendicular to a longitudinal direction of multi-core cable 10. The Z-axis perpendicular to the paper surface in FIG. 1 corresponds to an axis along the longitudinal directions of multi-core cable 10 and a core 100. The X-Y plane is a plane perpendicular to the longitudinal directions of multi-core cable 10 and core 100.

As shown in FIG. 1, multi-core cable 10 of the present embodiment includes core 100 formed of four insulated wires 11 twisted together, a shield layer 12 disposed on an outer side of core 100, and a jacket 13 disposed on an outer side of shield layer 12.

### (1) Members Included in Multi-Core Cable

Each member included in the multi-core cable of the present embodiment will be described.

### (1-1) Core

Core 100 has four insulated wires 11. Insulated wire 11 can be used for signal transmission, for example.

### (1-1-1) Configuration of Insulated Wire

Core 100 of multi-core cable 10 shown in FIG. 1 is constituted by two first wires 11A and two second wires 11B. Two first wires 11A can have the same configuration as each other. Two second wires 11B can have the same configuration as each other. Thus, four insulated wires 11 can also be said to have two sets of insulated wires. Two first wires 11A and two second wires 11B are twisted together to form core 100.

Insulated wires 11 can each include a conductor 111 and an insulator 112 covering an outer surface of conductor 111.

First wires 11A, which are insulated wires 11, can each include a first conductor 111A and a first insulator 112A covering an outer surface of first conductor 111A.

Second wires 11B, which are insulated wires 11, can each include a second conductor 111B and a second insulator 112B covering the outer surface of second conductor 111B.

Configuration examples of the members of insulated wires 11 will be described.

### (Conductor)

Conductor 111 can include a single conductor element wire or a plurality of conductor element wires. When conductor 111 has a plurality of conductor element wires, the plurality of conductor element wires may be twisted together. That is, when conductor 111 includes a plurality of conductor element wires, conductor 111 may be a stranded wire in which the plurality of conductor element wires are twisted together.

The material of conductor 111 is not particularly limited, and for example, one or more conductor materials selected from copper, silver-plated annealed copper, and tin-plated annealed copper can be used. Soft copper may be used as the copper.

An outside diameter of conductor 111, that is, an outside diameter D111A of first conductor 111A and an outside diameter D111B of second conductor 111B are not particularly limited, and may be, for example, 0.20 mm to 1.0 mm.

The outside diameter of conductor 111 is determined by measuring two diameters along two directions orthogonal to each other in any one cross-section perpendicular to a longitudinal direction of conductor 111 and averaging the measured two diameters.

### (Insulator)

The material of insulator 112 is not particularly limited, and can include a resin material.

As the resin material, for example, one or more resins selected from fluororesins such as polytetrafluoroethylene (PTFE), tetrafluoroethylene-perfluoroalkyl vinyl ether copolymer (PFA), tetrafluoroethylene-hexafluoropropylene copolymer (FEP), and ethylene-tetrafluoroethylene copolymer (ETFE), a polyester resin such as polyethylene terephthalate (PET), polyolefin resins such as polyethylene, polypropylene, and polymethylpentene, or the like can be used. The resin material contained in insulator 112 may be crosslinked or not crosslinked. When the resin material is a polyolefin resin such as polyethylene or polypropylene, the resin material is suitable for transmission of high-speed signals, and the cost can be particularly reduced.

Insulator 112 may be formed of only the resin material, but insulator 112 may contain one or more additives selected from a flame retardant, a flame retardant aid, an antioxidant, a lubricant, a colorant, a reflection imparting agent, a masking agent, a processing stabilizer, a plasticizer, and the like, in addition to the resin material.

### (1-1-2) Outside Diameters of First Wire and Second Wire

An outside diameter D11A of each of first wires 11A of multi-core cable 10 may be larger than an outside diameter D11B of each of second wires 11B.

Outside diameter D111A of first conductor 111A included in each of first wires 11A and outside diameter D111B of second conductor 111B included in each of second wires 11B may be the same as each other. Thus, for example, a thickness of first insulator 112A included in each of first wires 11A can be made larger than a thickness of second insulator 112B included in each of second wires 11B.

For example, a ratio of outside diameter D11B of each of second wires 11B to outside diameter D11A of each of first wires 11A, that is, a value of D11B/D11A may be set to 0.2 to 0.7.

By setting the ratio of outside diameter D11B of each of second wires 11B to outside diameter D11A of each of first wires 11A to 0.2 to 0.7, the shapes of the shield layer and the jacket can be made closer to a perfect circle in a cross-section of the multi-core cable perpendicular to the longitudinal direction of the multi-core cable. Thus, the handling properties of multi-core cable 10 can be improved. In addition, it is possible to suppress a variation in a distance between second wires 11B at positions along the longitudinal direction of multi-core cable 10, thereby particularly stabilizing the transmission characteristics of a signal propagated through second wires 11B.

Outside diameter D11A of each of first wires 11A and outside diameter D11B of each of second wires 11B are not particularly limited, and may be, for example, 0.6 mm to 2.6 mm.

The outside diameters of insulated wires 11, an outside diameter of multi-core cable 10 described later, and an element wire diameter of a metal element wire are determined by the same procedure as for conductor 111 except that the measurement targets are first wire 11A and second wire 11B which are insulated wires 11, multi-core cable 10, and the metal element wire, and thus the description thereof will be omitted.

### (1-1-3) Arrangement of First Wire and Second Wire

In a cross-section of core 100 perpendicular to a longitudinal direction of core 100, four insulated wires 11 can be arranged in such a manner that four insulated wires 11 form a single layer along the outside circumference of core 100, and each of first wires 11A alternates with each of second wires 11B along the outside circumference of core 100.

Thus, in the cross-section of core 100 perpendicular to the longitudinal direction of core 100, a center C11 and a center C12 of two first wires 11A are positioned on a first diagonal line L1 of a quadrangular shape S1 formed by a line connecting centers of the four insulated wires. A center C21 and a center C22 of two second wires 11B are positioned on a second diagonal line L2 of quadrangular shape S1. Quadrangular shape S1 is a figure formed by a line connecting center C11, center C12, center C21, and center C22 along the outside circumference of core 100. First diagonal line L1 and second diagonal line L2 are different diagonal lines of quadrangular shape S1.

Quadrangular shape S1, first diagonal line L1, second diagonal line L2, center C11, center C12, center C21, and center C22 are auxiliary lines or points for illustrating the arrangement of insulated wires 11, and do not form multi-core cable 10.

Two first wires 11A are in contact with each other at a contact portion P10. Two second wires 11B can be configured not to be in contact with each other.

Each of first wires 11A can be in contact with each of second wires 11B disposed adjacent along the outside circumference of core 100 to first wires 11A. Specifically, as shown in FIG. 1, at a contact portion P11, a contact portion P12, a contact portion P13, and a contact portion P14, first wires 11A are in contact with second wire 11B adjacent along the outside circumference of core 100 to first wires 11A. That is, four insulated wires 11 are in contact with respective adjacent insulated wires 11 along the outside circumference of core 100.

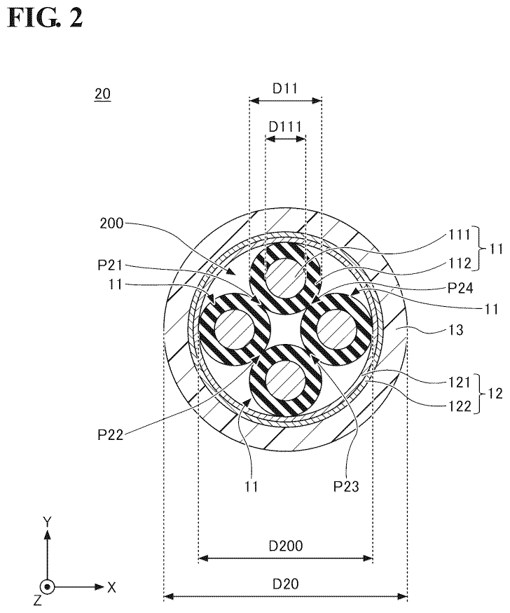

Conventionally, when four insulated wires are twisted together to form a multi-core cable, the multi-core cable has a configuration in which four insulated wires 11 having the same configuration such as outside diameter D11 are twisted together as in a multi-core cable 20 shown in FIG. 2. In multi-core cable 20, in a cross-section of a core 200 perpendicular to a longitudinal direction of core 200, insulated wires 11 adjacent to each other along the outside circumference of core 200 are in contact with each other at a contact portion P21, a contact portion P22, a contact portion P23, and a contact portion P24. However, insulated wires 11 positioned on a diagonal line of a quadrangular shape formed by a line connecting the centers of insulated wires 11 are not in contact with each other.

In contrast, multi-core cable 10 of the present embodiment is configured by two first wires 11A and two second wires 11B for four insulated wires 11 as described above, and outside diameter D11A of each of first wires 11A is larger than outside diameter D11B of each of second wires 11B. In addition, two first wires 11A are disposed so as to be in contact with each other in the cross-section of core 100 perpendicular to the longitudinal direction of core 100. According to the study by the inventors of the present invention, by disposing two first wires 11A to be in contact with each other in the cross-section of core 100 perpendicular to the longitudinal direction of core 100 as in multi-core cable 10, the occurrence of suck-out can be suppressed for signals propagating through the first wires.

### (1-2) Shield Layer

Shield layer 12 may be disposed on the outer side of core 100.

Since multi-core cable 10 includes shield layer 12, it is possible to suppress noise on signals propagating through insulated wires 11. In addition, the influence of noise on external devices can be suppressed.

Shield layer 12 can include a conductive material.

For example, shield layer 12 can be formed by spirally winding a conductive tape including a conductive layer along the longitudinal direction of core 100.

The conductive tape can include a base material and a conductive layer disposed on at least one of an upper surface and a lower surface of the base material. The conductive tape may have conductive layers on both the upper surface and the lower surface of the base material. The conductive tape may be formed of only the conductive layer without having the base material.

The material of the conductive layer is not particularly limited, and can include a metal, and may be, for example, a metal foil. When the conductive layer contains a metal, the material of the metal is not particularly limited, and for example, copper, copper alloy, aluminum, aluminum alloy, or the like can be used.

The material of the base material is not particularly limited, and for example, an insulating material such as an organic polymer material or a nonwoven fabric may be used. Examples of the organic polymer material include a polyester resin such as polyethylene terephthalate (PET), a polyolefin resin such as polypropylene, and a vinyl resin such as polyvinyl chloride. The base material can contain an insulating material, and may be made of only an insulating material.

Thus, as the conductive tape, for example, one or more types selected from a copper-laminated polyester tape, an aluminum-laminated polyester tape, and the like can be used.

As described above, when the conductive tape is wound to form shield layer 12, the winding direction of the conductive tape may be arbitrarily selected, and for example, may be the same direction as the twisting direction of four insulated wires 11 included in core 100, or may be a different direction.

Shield layer 12 may also include a metal element wire. In this case, shield layer 12 can have a structure in which the metal element wires are transversely wounded or braided. When shield layer 12 includes the metal element wire, the metal element wires are braided to increase the mechanical strength of the shield layer, and thus the durability of the multi-core cable can be increased.

As the material of the metal element wire, copper, aluminum, copper alloy, or the like can be used. As the metal element wire, an annealed copper wire may be used. The metal element wire may be plated with silver or tin on the surface. Thus, the metal element wire may be a silver-plated annealed copper wire or a tin-plated annealed copper wire.

The metal element wire may be one or more wires selected from, for example, an annealed copper wire, a tin-plated annealed copper wire, and the like, and thus the cost can be particularly reduced.

Shield layer 12 may be formed of a plurality of layers instead of a single layer. As shown in FIG. 1, shield layer 12 may include a first shield layer 121 and a second shield layer 122 in order from a position close to core 100. In this case, for example, first shield layer 121 can be a layer formed by spirally winding a conductive tape along the longitudinal direction of core 100. For example, second shield layer 122 may be a layer formed by transversely winding or braiding the metal element wire. Multi-core cable 10 of the present embodiment may have two layers of second shield layer 122 formed by transversely winding or braiding the metal element wire, and in this case, shield layer 12 may include three layers including first shield layer 121.

### (1-3) Jacket

Jacket 13 can be disposed on the outer side of shield layer 12.

Since multi-core cable 10 has jacket 13, insulated wires 11 included in core 100 are protected, the electrical short circuit of shield layer 12 is prevented, and the durability of multi-core cable 10 is enhanced.

### (Resin Material)

Jacket 13 can include a resin material. The resin material is not particularly limited, and for example, one type selected from a polyolefin resin such as polyethylene or an ethylene-vinyl acetate copolymer (EVA), polyvinyl chloride, a polyurethane elastomer (polyurethane resin), and a polyester elastomer, or a composition formed by mixing at least two types thereof can be used. When the resin material is one or more resins selected from polyolefin resin and polyvinyl chloride, the cost can be particularly reduced.

The resin material of jacket 13 may be crosslinked or not crosslinked.

### (1-4) Wrapping Tape

Multi-core cable 10 may have a wrapping tape (not shown) that covers the outer surface of core 100. The wrapping tape can be disposed, for example, between core 100 and shield layer 12.

Since multi-core cable 10 has the wrapping tape, four insulated wires 11 of multi-core cable 10 can be stably disposed and bundled.

As the wrapping tape, for example, a resin tape such as polyethylene terephthalate (PET) can be used.

The winding direction of the wrapping tape may be the same as or different from the twisting direction of four insulated wires 11 included in core 100.

### (2) Shape of Multi-Core Cable

Multi-core cable 10 can have a circular shape in the cross-section perpendicular to the longitudinal direction, for example, as shown in FIG. 1. In the cross-section of multi-core cable 10 perpendicular to the longitudinal direction of multi-core cable 10, a ratio of the minimum value of the outside diameter of multi-core cable 10 to the maximum value of the outside diameter of multi-core cable 10, that is, a value obtained by the minimum value divided by the maximum value is not particularly limited, and may be set to 0.9 to 1.0, for example.

By setting the ratio of the minimum value of the outside diameter of multi-core cable 10 to the maximum value of the outside diameter of multi-core cable 10 in the cross-section perpendicular to the longitudinal direction to 0.9 to 1.0, the cross-sectional shape of multi-core cable 10 can be made closer to a perfect circle, and the handling properties of multi-core cable 10 can be improved.

An outside diameter D10 of multi-core cable 10 is not particularly limited, and may be, for example, 2.0 mm to 9.0 mm. By setting outside diameter D10 of multi-core cable 10 to 2.0 mm or more, the thickness of jacket 13 or the like is sufficiently ensured, and the durability of multi-core cable 10 can be enhanced. By setting outside diameter D10 of multi-core cable 10 to 9.0 mm or less, the flexibility of multi-core cable 10 is improved, and the handling properties are enhanced.

### Example

The present invention will be described below with reference to specific examples, but the present invention is not limited to these examples.

### (Evaluation Method)

First, a method for evaluating multi-core cables produced in the following experimental examples will be described.

### (1) Outside Diameter of Conductor, Insulated Wire, Core, and Multi-Core Cable

The outside diameters of the conductor, the insulated wires, the core, and the multi-core cable were measured in accordance with JIS C 3005 (2014).

Specifically, for example, in any one cross-section perpendicular (at right angles) to the longitudinal direction of insulated wires 11, the outside diameters of conductor 111 were measured along two directions orthogonal to each other, and the average value was determined as an outside diameter D111 of conductor 111.

Although conductor 111 has been described as an example, outside diameter D11 of insulated wires 11, an outside diameter D100 of core 100, outside diameter D10 of multi-core cable 10, and the like were also obtained by the same procedure except that insulated wires 11, core 100, and multi-core cable 10 were set as the evaluation targets. For multi-core cable 10 shown in FIG. 1, the measurement was performed for each of first wires 11A and second wires 11B as insulated wires 11. For multi-core cable 20 shown in FIG. 2, an outside diameter D200 of core 200 and an outside diameter D20 of multi-core cable 20 were measured.

In Experimental Example 1, the ratio (D11B/D11A) of outside diameter D11B of each of second wires 11B to outside diameter D11A of each of first wires 11A was calculated.

### (2) Characteristic Impedance

The characteristic impedances of first wires 11A of the multi-core cable produced in the following experimental examples were measured by a time domain reflectometry (TDR) method. In Experimental Example 2, the measurement is performed on insulated wires 11 instead of first wires 11A. The same applies to a skew and an attenuation described below.

### (3) Skew

An electric pulse was sent to two first wires 11A included in a multi-core cable produced in the following experimental examples by a digital serial analyzer, and a delay time per 1 m was measured to determine a skew.

### (4) Attenuation

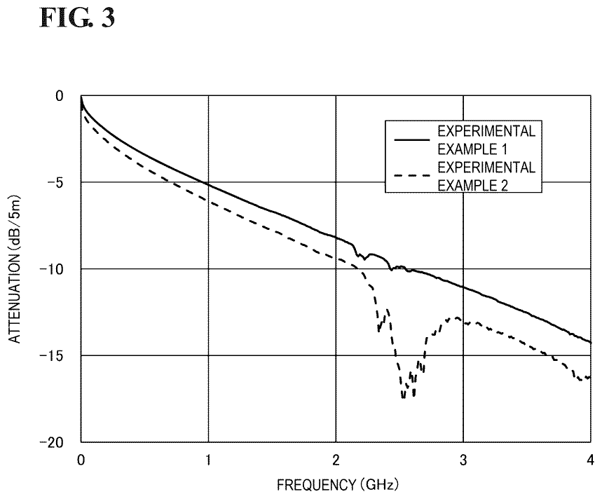

An attenuation was measured for first wires 11A in a 5-meter-long multi-core cable produced in each of the following experimental examples using a network analyzer. The results are shown in FIG. 3. Table 2 shows the attenuation for a 2 GHz signal.

### Experimental Conditions and Results

The multi-core cable produced in each experimental example will be described below.

Multi-core cables were produced in Experimental Example 1 and Experimental Example 2 described below. Experimental Example 1 is a working example, and Experimental Example 2 is a comparative example.

### Experimental Example 1

Multi-core cable 10 having the structure shown in FIG. 1 in the cross-section perpendicular to the longitudinal direction was produced. The size of each part of multi-core cable 10 is shown in Table 1. The results of measuring the characteristic impedance, skew, and attenuation for obtained multi-core cable 10 are shown in Table 2 and FIG. 3.

### Experimental Example 2

Multi-core cable 20 having the structure shown in FIG. 2 in the cross-section perpendicular to the longitudinal direction was produced. In multi-core cable 20, four insulated wires 11 have the same configuration, and have the same outside diameter D11 as shown in Table 1. The size of each part of multi-core cable 20 is shown in Table 1. The results of measuring the characteristic impedance, skew, and attenuation for obtained multi-core cable 20 are shown in Table 2 and FIG. 3.

As shown in FIG. 3, in the multi-core cable of Experimental Example 2, a sharp drop in attenuation was observed around 2.5 GHZ. As shown in Table 2, the attenuation at 2 GHz was improved by 13% in Experimental Example 1 as compared with Experimental Example 2.

TABLE 1

| | | | EXPERIMENTAL | EXPERIMENTAL |
|---|---|---|---|---|
| | | | EXAMPLE 1 | EXAMPLE 2 |
| INSULATED | FIRST WIRE | OUTSIDE DIAMETER D111A OF | 0.48 | 0.48 |
| WIRE | | FIRST CONDUCTOR, | | |
| | | OUTSIDE DIAMETER D111 OF | | |
| | | CONDUCTOR 111 (mm) | | |
| | | OUTSIDE DIAMETER D11A OF | 1.26 | 1.10 |
| | | FIRST WIRE 11A, | | |
| | | OUTSIDE DIAMETER D11 OF | | |
| | | INSULATED WIRE 11 (mm) | | |
| | SECOND | OUTSIDE DIAMETER D1118 OF | 0.48 | — |
| | WIRE | SECOND CONDUCTOR (mm) | | |
| | | OUTSIDE DIAMETER D11B OF | 0.84 | — |
| | | SECOND WIRE 11B (mm) | | |

| | | | |
|---|---|---|---|
| | D11B/D11A | 0.67 | 1.00 |
| CORE | OUTSIDE DIAMETER D100, D200 (mm) | 2.50 | 2.66 |

| | | |
|---|---|---|
| OUTSIDE DIAMETER D10, D20 (mm) | 4.6 | 4.6 |

TABLE 2

| | CHARACTERISTIC | Skew | ATTENUATION |
|---|---|---|---|
| | IMPEDANCE (Ω) | (ps/m) | (@2 GHz) (dB/5 m) |
| EXPERIMENTAL | 98.2 | 2.8 | −8.2 |
| EXAMPLE 1 | | | |
| EXPERIMENTAL | 97.7 | 5.7 | −9.4 |
| EXAMPLE 2 | | | |

What is claimed is:

1. A multi-core cable comprising:
a core formed of four insulated wires twisted together;
a shield layer disposed on an outer side of the core; and
a jacket disposed on an outer side of the shield layer,
wherein the four insulated wires are constituted by two first wires and two second wires,
wherein an outside diameter of each of the first wires is larger than an outside diameter of each of the second wires, and
wherein, in a cross-section of the core perpendicular to a longitudinal direction of the core, a center of each of the two first wires is positioned on a first diagonal line of a quadrangular shape that is formed by a line connecting centers of the four insulated wires, and a center of each of the two second wires is positioned on a second diagonal line of the quadrangular shape, the two first wires being in contact with each other, the first wires being in contact with the second wires disposed adjacent along an outside circumference of the core to the first wires.

2. The multi-core cable according to claim 1,
wherein a ratio of the outside diameter of each of the second wires to the outside diameter of each of the first wires is 0.2 to 0.7.

3. The multi-core cable according to claim 1,
wherein, in a cross-section of the multi-core cable perpendicular to a longitudinal direction of the multi-core cable, a ratio of a minimum value of an outside diameter of the multi-core cable to a maximum value of the outside diameter of the multi-core cable is 0.9 to 1.0.
